(19) United States
(12) Patent Application Publication
(10) Pub. No.: US 2005/0208251 A1
(43) Pub. Date: Sep. 22, 2005

(54) Low cost electrically conductive tapes and films manufactured from conductive loaded resin-based materials

(75) Inventor: Thomas Aisenbrey, Littleton, CO (US)

Correspondence Address: GEORGE O. SAILE, 28 DAVIS AVENUE, POUGHKEEPSIE, NY, 12603, US

(73) Assignee: Integral Technologies, Inc.

(21) Appl. No.: 11/083,467

(22) Filed: Mar. 18, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/557,893, filed on Mar. 31, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. B32B 9/00

(52) U.S. Cl. 428/40.1

(57) ABSTRACT

Electrically conductive tapes and films are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

This Patent Application claims priority to the U.S. Provisional Patent Application 60/557,893 filed on Mar. 31, 2004, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. Patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to electrically conductive tapes and films and, more particularly, to electrically conductive tapes and films molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Conductive tapes and films find a wide variety of uses. In particular, electrically conductive tapes and films are useful in electronics devices for electromagnetic shielding and chassis grounding. Thermally conductive tapes may be used for thermal management in electronic devices. A particular challenge in conductive tape and film construction is creating high electrical and/or thermal conductivity. Typically, this is achieved by using a metal foil in the tape or film construction. However, metal foils are typically fragile and not tolerant of corrosive environments. An important object of the present invention is to create tapes and films combining very high electrical and thermal conductivity with the flexibility, durability, and other capabilities of a resin-based material.

Several prior art inventions relate to conductive tapes. U.S. Pat. No. 4,988,550 to Keyser et al teaches a conductive maskable EMI tape for shielding applications that utilizes a metal foil layer with a conductive adhesive and an outer mask covering that can be removed after the interior of the item to be shielded is painted. U.S. Pat. No. 5,510,174 to Litman teaches thermally conductive materials containing titanium diboride fillers in order to render them thermally and electrically conductive. This invention teaches the use of these fillers in forming films, tapes, compounds, adhesives and greases. U.S. Patent Publication US 2004/0041131 A1 to Fukushima et al teaches a electro-conductive silicone pressure-sensitive adhesive composition that utilizes a conductive metal coated powder in a silicon-base polymer for use in electromagnetic shielding. U.S. Patent Publication US 2003/0091777 A1 to Jones et al teaches a clean releasable tape for EMI shielding that utilizes noble and non-noble metals such as nickel, copper, tin, and aluminum as the electrically conductive filler in the pressure sensitive adhesive and a metal foil or metal-plated fabric as the outer layer. U.S. Patent Publication US 2002/0195228 to Corti et al teaches a thermal enhanced extended surface tape for integrated circuit heat dissipation that utilizes an extended surface area.

### SUMMARY OF THE INVENTION

A principal object of the present invention is to provide an effective conductive tape or film.

A further object of the present invention is to provide a conductive tape or film exhibiting high electrical conductivity.

A further object of the present invention is to provide a conductive tape or film exhibiting high thermal conductivity.

A further object of the present invention is to provide a conductive tape or film further exhibiting magnetic capability.

A further object of the present invention is to provide a conductive tape or film comprising a conductive mesh or fabric.

A yet further object of the present invention is to provide a conductive tape or film molded of conductive loaded resin-based material where the visual, conductive, or thermal characteristics can be altered by further forming a metal layer over the conductive loaded resin-based material.

A yet further object of the present invention is to provide methods to fabricate a conductive tape or film from a conductive loaded resin-based material incorporating various forms of the material.

In accordance with the objects of this invention, a conductive tape device is achieved. The device comprises a backing layer of conductive loaded resin-based material comprising conductive materials in a base resin host. An adhesive layer is adhered to the backing layer.

Also in accordance with the objects of this invention, a conductive tape device is achieved. The device comprises a backing layer of conductive loaded resin-based material comprising conductive materials in a base resin host. The weight of the conductive materials is between 20% and 50% of the total weight of the conductive loaded resin-based material. An adhesive layer is adhered to the backing layer.

Also in accordance with the objects of this invention, a conductive tape device is achieved. The device comprises a backing layer of conductive loaded resin-based material comprising conductive materials in a base resin host. The weight of the conductive materials is between 20% and 50% of the total weight of the conductive loaded resin-based material. A first adhesive layer is adhered to the backing layer. A second adhesive layer is adhered to the backing layer on the side opposite the first adhesive layer.

Also in accordance with the objects of this invention, a method to form a conductor tape device is achieved. The method comprises providing a conductive loaded, resin-based material comprising conductive materials in a resin-based host. The conductive loaded, resin-based material is formed into a backing layer. An adhesive layer is adhered to the backing layer.

Also in accordance with the objects of this invention, a method to form a conductor tape device is achieved. The method comprises providing a conductive loaded, resin-based material comprising conductive materials in a resin-based host. The weight of the conductive materials is between 20% and 50% of the total weight of the conductive loaded resin-based material. The conductive loaded, resin-based material is formed into a backing layer. An adhesive layer is adhered to the backing layer.

Also in accordance with the objects of this invention, a method to form a conductor tape device is achieved. The method comprises providing a conductive loaded, resin-based material comprising conductive materials in a resin-based host. The weight of the conductive materials is between 20% and 50% of the total weight of the conductive loaded resin-based material. The conductive loaded, resin-based material is formed into a backing layer. A first adhesive layer is adhered to the backing layer. A second adhesive layer is adhered to the backing layer on the side opposite the first adhesive layer.

### BRIEF DESCRIPTION OF THE DRAWINGS

In the accompanying drawings forming a material part of this description, there is shown:

FIGS. 1a and 1b illustrates a first preferred embodiment of the present invention showing conductive tape or films formed of conductive loaded resin-based material according to the present invention.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold electrically conductive tapes and films of a conductive loaded resin-based material.

FIG. 7 illustrates a second preferred embodiment of the present invention showing a two-sided conductive tape and film.

FIG. 8 illustrates a third preferred embodiment of the present invention showing a conductive loaded resin-based conductive tape or film having a topology that increases surface area to optimize heat transfer.

FIG. 9 illustrates a fourth preferred embodiment of the present invention showing a conductive tape or film using a conductive loaded resin-based material mesh or fabric.

FIG. 10 illustrates a fifth preferred embodiment of the present invention showing a conductive loaded resin-based material conductive tape or film having a metal layer.

### DESCRIPTION OF THE PREFERRED EMBODIMENTS

This invention relates to electrically conductive tapes and films molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of electrically conductive tapes and films fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the electrically conductive tapes and films are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

The use of conductive loaded resin-based materials in the fabrication of electrically conductive tapes and films significantly lowers the cost of materials and the design and manufacturing processes used to hold ease of close tolerances, by forming these materials into desired shapes and sizes. The electrically conductive tapes and films can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, aluminum fiber, or the like, or combinations thereof. Superconductor metals, such as titanium, nickel, niobium, and zirconium, and alloys of titanium, nickel, niobium, and zirconium may also be used as micron conductive fibers in the present invention. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the electrically conductive tapes and films. The doping composition and directionality associated with the micron conductors within the loaded base resins can affect the electrical and structural characteristics of the electrically conductive tapes and films and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming electrically conductive tapes and films that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in electrically conductive tapes and films as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/dr micron conductive powder into a base resin.

As an additional and important feature of the present invention, the molded conductor loaded resin-based material exhibits excellent thermal dissipation characteristics. Therefore, electrically conductive tapes and films manufactured from the molded conductor loaded resin-based material can provide added thermal dissipation capabilities to the application. For example, heat can be dissipated from electrical devices physically and/or electrically connected to electrically conductive tapes and films of the present invention.

As a significant advantage of the present invention, electrically conductive tapes and films constructed of the conductive loaded resin-based material can be easily interfaced to an electrical circuit or grounded. In one embodiment, a wire can be attached to a conductive loaded resin-based electrically conductive tapes and films via a screw that is fastened to the electrically conductive tapes and films. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the electrically conductive tape of film and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Superconductor metals, such as titanium, nickel, niobium, and zirconium, and alloys of titanium, nickel, niobium, and zirconium may also be used as micron conductive fibers in the present invention. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

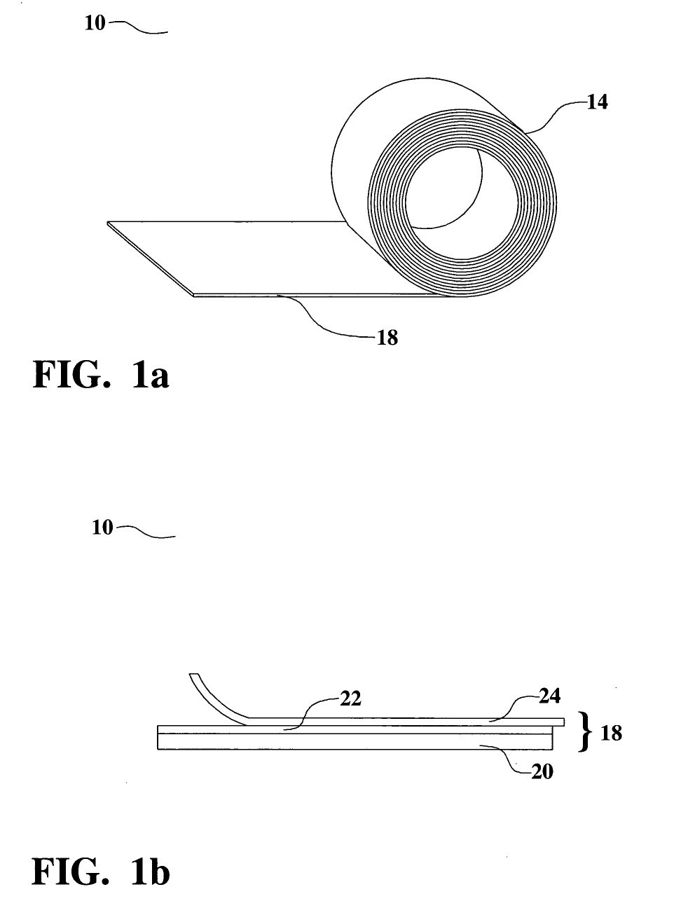

Referring now to FIGS. 1a and 1b, a first preferred embodiment of the present invention is illustrated. Several important features of the present invention are shown and discussed below. Very low cost, flexible, conductive tape and film material 10 comprising conductive loaded resin-based materials are shown. Referring particularly to FIG. 1a, a roll 14 of conductive tape or film is formed of a long piece 18 of the conductive tape or film material of this invention. This conductive tape 18 bears the unique properties of the conductive loaded resin-based material, including excellent electrical conductivity, excellent thermal conductivity, excellent absorption of electromagnetic energy, and the like. Referring particularly to FIG. 1b, the tape 18 comprises a backing 20 comprising the conductive loaded resin-based material and an adhesive layer 22 formed onto the backing. Optionally, a release material 24, such as a coated paper, is adhered to the adhesive layer to permit ease of handling and transport.

The conductive loaded resin-based material 20 is first formed into a thin sheet. In one embodiment, the thin sheet 20 is formed by extruding molten conductive loaded resin-based material through an opening. In another embodiment, the thin sheet 20 is formed by calendaring the conductive loaded resin-based material. In a calendaring process, the material is progressively thinned by pressing and rolling.

The adhesive layer 22 is then applied to the backing 20. In one embodiment, the adhesive layer 22 is rolled onto the backing. In another embodiment, the adhesive layer 22 is applied by spraying. In another embodiment, the adhesive layer 22 is co-extruded with the backing 20. The adhesive layer 22 may comprise any of several types of materials, depending on the application. In one embodiment, the adhesive layer 22 is a pressure sensitive adhesive (PSA). In this case, the adhesive 22 is a resin-based material having a glass transition temperature or other surface properties that cause the material to exhibit tackiness at normal room temperature. In this case, the tape or film 18 is applied to an object and pressed into place. The tackiness of the adhesive 22 will maintain the tape or film 18 placement. In another embodiment, the adhesive 22 comprises a thermosetting resin-based material. In this case, the adhesive may not exhibit tackiness at room temperature. However, the adhesive 22 will bond with the surface of the object to which has been applied when subjected to heating or other chemical reaction.

If the conductive tape or film 18 is used to provide a conductive path between the adhered object and the conductive loaded resin-based backing 20, then the adhesive layer 22 should also be conductive. Conductive adhesive materials are well-known in the art. If the conductive tape or film 18 is used to provide a conductive path through the conductive loaded resin-based backing 20, but this conductive path does not include the adhered object, then a non-conductive adhesive layer 22 is chosen.

The release material 24, if used, is applied to the adhesive layer 22. The release material 24 is particularly useful where the adhesive layer 22 exhibits tackiness at room temperature. The release material 24 allows the tape or film 18 to be handled and to be placed into position without sticking to itself.

The conductive tape or film 18 provides a conductive path wherever it is applied. Therefore, the tape or film 18 is useful, for example, for providing grounding paths between a circuit board and a chassis or case. Further, the tape or film 18 is useful for improving the conductive connection between different parts of a chassis or case. As an additional feature, where the conductive tape or film 18 is applied over an opening or along a seal, it is useful for forming an environmental seal to prevent contamination or moisture entering the chassis. As yet an additional feature, where the conductive tape or film 18 is applied to an electronic device, it is useful for absorbing electromagnetic energy.

In yet another embodiment, a ferromagnetic material is added to the conductive loaded resin-based material of the present invention, as described above, so that a magnetic or magnetizable material is produced. Where the ferromagnetic conductive loaded resin-based material is formed into a tape or film 18, then this tape or film 18 can be used as a magnetic strip or as a magnetizable strip.

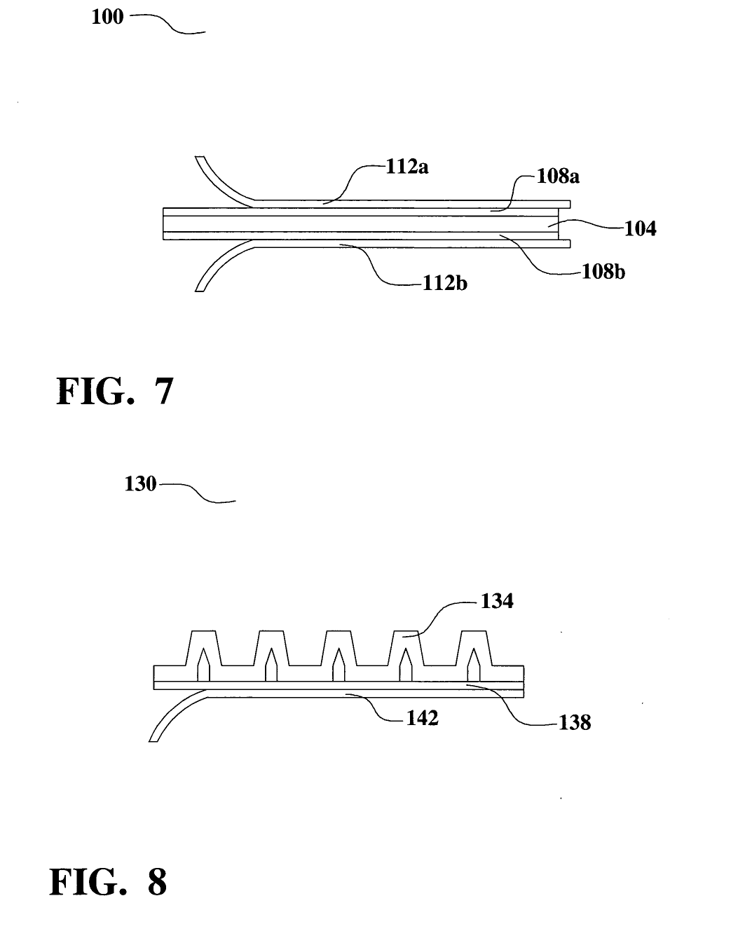

Referring now to FIG. 7, a second preferred embodiment of the present invention is illustrated. In particular, a two-sided tape or film 100 is shown. In a two-sided tape or film 100, adhesive layers 108a and 108b are applied to each side of the conductive loaded resin-based material backing 104. Optionally, release layers 112a and 112b are applied to each adhesive layer 108a and 108b. The two-sided conductive tape or film 100 is particularly useful as an adhering interface between materials. For example, electronics chassis often have openings for connectors or cables. Gaskets are typically applied to seal these openings from water intrusion. Further, if a conductive gasket is used, then the openings are also sealed from leakage or intrusion of electromagnetic energy. The two-sided conductive tape or film 100 of the present invention is ideally suited as the adhering interface between such a gasket and an electronics system chassis.

Referring now to FIG. 8, a third preferred embodiment of the present invention is illustrated. In this embodiment, a tape or film 130 is shown having a conductive loaded resin-based material backing layer 134 with an increased surface area topology. A corrugated pattern is formed into the tape or film 134. An adhesive layer 138 is attached to the backing layer 134. An optional release layer 142 is shown. This embodiment is particularly useful where the tape or film 130 is applied as a heat sink or heat transfer device. In this case, the adhesive layer 138 comprises a heat conductive material, such as is well known in the art. The tape backing 134 is applied to a heat generating device, such as an electronic device chassis, via the adhesive layer 138. Heat is transferred through the adhesive layer 138 and into the backing 134. The excellent thermal conductivity of the backing layer 134 pulls heat out of the attached device. This heat is then efficiently carried to the ambient media via convection due to the large surface area of the corrugated backing layer 134. This embodiment of a backing layer 134 may be generated, for example, by processing a conductive loaded resin-based material sheet through a gear mechanism prior to applying the adhesive layer 138.

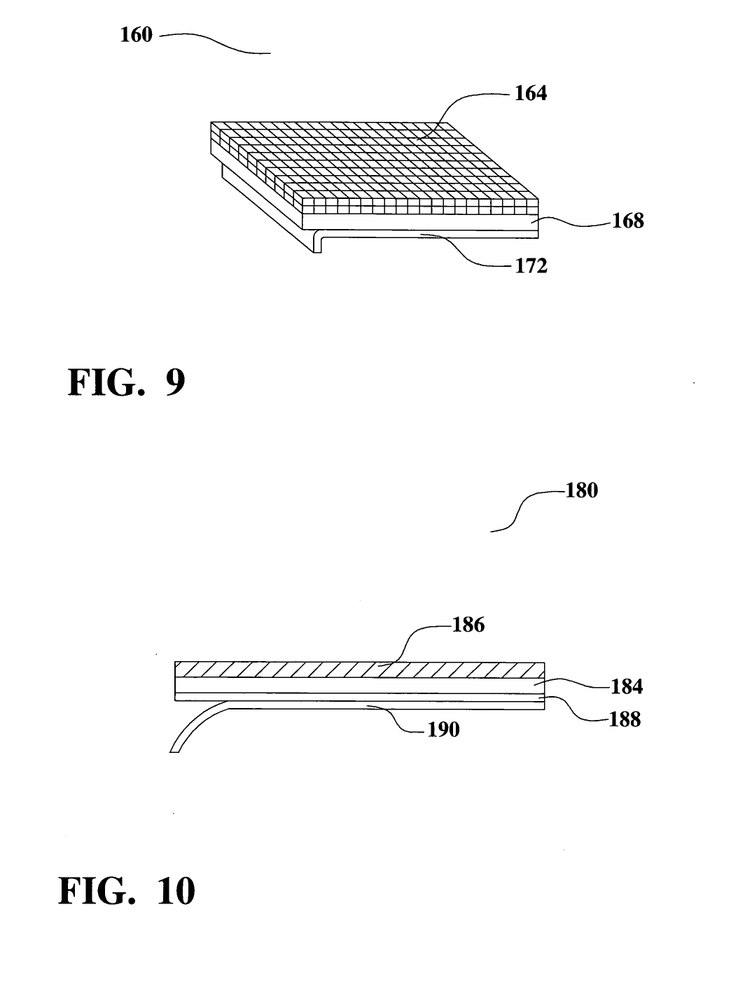

Referring now to FIG. 9, a fourth preferred embodiment of the present invention is illustrated. A tape or film 160 having a fabric or mesh backing 164 comprising the conductive loaded resin-based material is shown. An adhesive layer 168 is applied to the fabric or mesh backing 164. An optional release layer 172 is shown. In one embodiment, the fabric or mesh 164 is formed by extruding threads of the conductive loaded resin-based material and then weaving or webbing these threads into a conductive fabric. This embodiment is particularly useful for applications where the tape or film 160 is applied onto an irregularly shaped object. The flexible fabric or mesh 164 backing fits onto contours of the object, and the adhesive layer 168 holds the tape or film 160 in place.

Referring now to FIG. 10, a fifth preferred embodiment of the present invention is illustrated. A conductive loaded resin-based electrically conductive tape or film 180 having a metal layer 186 is shown. A backing layer 184 of the conductive loaded resin-based material is formed as earlier described. A metal layer 186 is then formed onto the backing layer 184. The metal layer 186 may be applied to alter the appearance characteristics and/or the electrical or thermal characteristics of the electrically conductive tapes and films. The metal layer 186 may be formed by plating or by coating. If the method of formation is metal plating 186, then the resin-based structural material of the conductive loaded, resin-based material should comprise a resin-based material that can be metal plated. The metal layer may be formed by, for example, electroplating or physical vapor deposition. An adhesive layer 188 is applied to the backing layer 186. An optional release layer 180 may be applied to the adhesive layer 188.

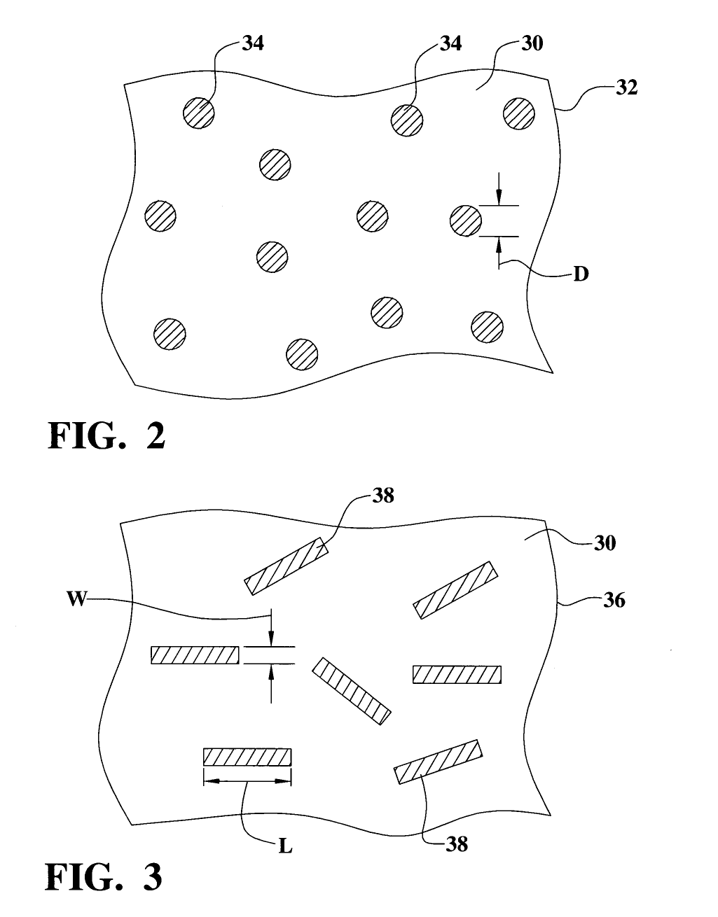

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

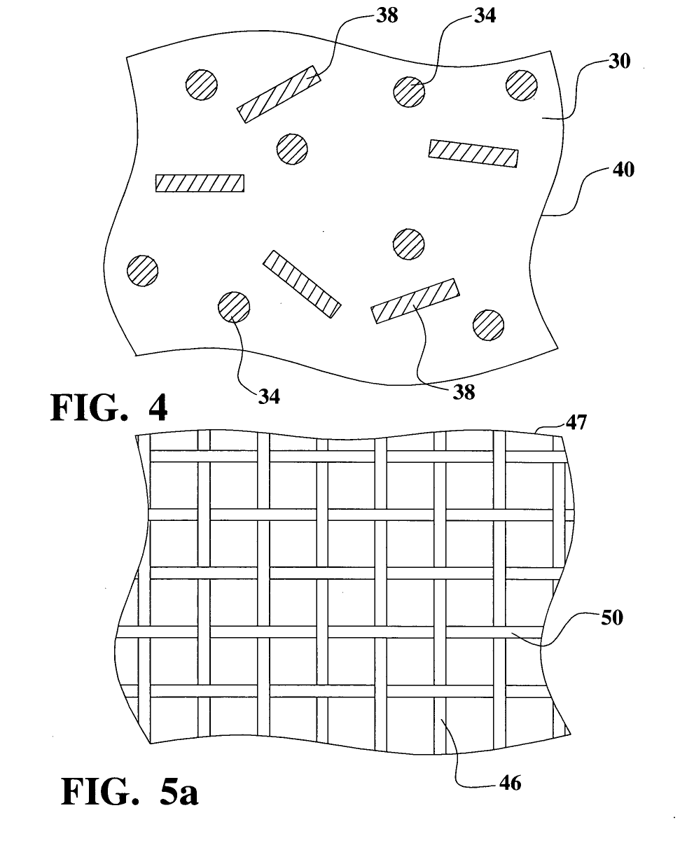

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. Superconductor metals, such as titanium, nickel, niobium, and zirconium, and alloys of titanium, nickel, niobium, and zirconium may also be used as micron conductive fibers in the present invention. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

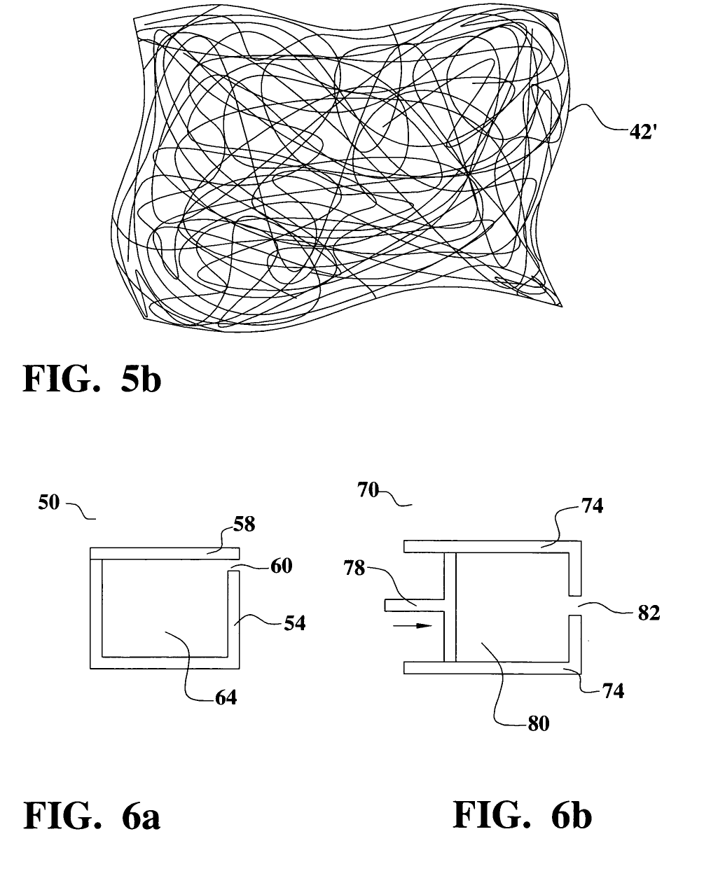

Electrically conductive tapes and films formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the electrically conductive tapes and films are removed.

FIG. 6b shows a simplified schematic diagram of an extruder 70 for forming electrically conductive tapes and films using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective conductive tape or film is achieved. The conductive tape or film exhibits high electrical conductivity, high thermal conductivity, and/or magnetic capability. A conductive tape or film comrpising a mesh or fabric is achieved. The visual, conductive, or thermal characteristics of the conductive tape or film can be altered by further forming a metal layer over the conductive loaded resin-based material. A conductive tape or film from a conductive loaded resin-based material incorporating various forms of the material is achieved.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A conductive tape device comprising:
a backing layer of conductive loaded resin-based material comprising conductive materials in a base resin host; and
an adhesive layer adhered to said backing layer.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 further comprising a release layer adhered to said adhesive layer.

7. The device according to claim 1 further comprising a second adhesive layer adhered to said backing layer on the side opposite said adhesive layer.

8. The device according to claim 1 wherein said backing layer comprises a fabric or mesh of said conductive loaded resin-based material.

9. The device according to claim 1 wherein said conductive loaded resin-based material further comprises ferromagnetic loading such that said backing layer is magnetic.

10. The device according to claim 1 further comprising a metal layer overlying said backing layer.

11. A conductive tape device comprising:
a backing layer of conductive loaded resin-based material comprising conductive materials in a base resin host wherein the weight of said conductive materials is between 20% and 50% of the total weight of said conductive loaded resin-based material; and
an adhesive layer adhered to said backing layer.

12. The device according to claim 12 wherein said conductive materials are nickel plated carbon micron fiber, stainless steel micron fiber, copper micron fiber, silver micron fiber or combinations thereof.

13. The device according to claim 12 wherein said conductive materials comprise micron conductive fiber and conductive powder.

14. The device according to claim 13 wherein said conductive powder is nickel, copper, or silver.

15. The device according to claim 13 wherein said conductive powder is a non-conductive material with a metal plating of nickel, copper, silver, or alloys thereof.

16. The device according to claim 11 further comprising a second adhesive layer adhered to said backing layer on the side opposite said adhesive layer.

17. The device according to claim 11 wherein said backing layer comprises a fabric or mesh of said conductive loaded resin-based material.

18. The device according to claim 11 wherein said conductive loaded resin-based material further comprises ferromagnetic loading such that said backing layer is magnetic.

19. The device according to claim 11 further comprising a metal layer overlying said backing layer.

20. A conductive tape device comprising:
a backing layer of conductive loaded resin-based material comprising micron conductive fiber in a base resin host wherein the weight of said micron conductive fiber is between 20% and 50% of the total weight of said conductive loaded resin-based material;
a first adhesive layer adhered to said backing layer; and
a second adhesive layer adhered to said backing layer on the side opposite said first adhesive layer.

21. The device according to claim 20 wherein said micron conductive fiber is stainless steel.

22. The device according to claim 20 further comprising conductive powder.

23. The device according to claim 20 wherein said micron conductive fiber has a diameter of between about 3 μm and about 12 μm and a length of between about 2 mm and about 14 mm.

24. The device according to claim 20 wherein said backing layer comprises a fabric or mesh of said conductive loaded resin-based material.

25. The device according to claim 20 wherein said conductive loaded resin-based material further comprises ferromagnetic loading such that said backing layer is magnetic.
